(19) United States
(12) Patent Application Publication
(10) Pub. No.: US 2019/0228892 A1
(43) Pub. Date: Jul. 25, 2019

(54) Coating Layers of Ferromagnetic Particles Surfaces for Obtaining Soft Magnetic Composites (SMCS)

(71) Applicant: Whirlpool S.A., Sao Paulo (BR)

(72) Inventors: Mauricio Valencia Ferreira DA LUZ, Florianopolis (BR); Rento CARLSON, Florianopolis (BR); Nelson SADOWSKI, Florianopolis (BR); Gisele HAMMES, Florianopolis (BR); Valderes DRAGO, Florianopolis (BR); Gustavo TONTINI, Florianopolis (BR); Aloisio Nelmo KLEIN, Florianopolis (BR); Cristiano BINDER, Florianopolis (BR); Joao Batista RODRIGUES NETO, Florianopolis (BR); Nelson Jhoe BATISTELA, Florianopolis (BR); Maisa Topanotti DAROS, Sao Jose (BR); Antonio Itamar RAMOS FILHO, Florianopolis (BR); Claudio SCHMITZ, Florianopolis (BR); Ricardo De Araujo ELIAS, Florianopolis (BR)

(21) Appl. No.: 16/328,011

(22) PCT Filed: Aug. 25, 2017
(86) PCT No.: PCT/BR2017/050245

§ 371 Date: Feb. 25, 2019

(30) Foreign Application Priority Data
Aug. 25, 2016 (BR) BR1020160196817
Aug. 24, 2017 (BR) BR1020170182037

(51) Int. Cl. H01F 1/33; H01F 1/24

(52) U.S. Cl. CPC H01F 1/33; H01F 1/24

(57) ABSTRACT

The present invention describes the process for enriching the surface of ferromagnetic particles and coating ferromagnetic particles. More specifically the present invention describes the obtainment of materials developed by processes of: surface enrichment, surface oxidation, particle coating via dry powder mixing by tumbling, via reactions with boron compounds, via liquid glassy suspension and non-metallic compounds, and the possibility of using one or more of the techniques described concomitantly. The present invention is in the field of Mechanical Engineering, Electrical Engineering, Chemical Engineering and Materials Engineering.

### FIELD OF THE INVENTION

The present invention describes a process for enriching particle surface layer and coating particles. The present invention is in the field of Mechanical Engineering, Electrical Engineering, Chemical Engineering and Materials Engineering.

### BACKGROUND OF THE INVENTION

Different methods of producing materials called SMCs (Soft Magnetic Composites) are currently being studied, aiming at developing industrially viable and economically sustainable methodologies.

The SMC consists of a ferromagnetic powder composite coated with insulating material which, when combined with powder metallurgy techniques, is an alternative to steels for electromagnetic purposes of great technological interest, such as rotary machines, sensors and solenoids of fast switching, motors etc.

As each iron powder particle is coated with an insulating material, the electrical resistivity of the components (parts) produced with the coated particles is increased, decreasing the magnetic losses of the component by parasitic currents. The efficiency of the components manufactured in SMCs in relation to laminated electrical steels increases for medium and high frequency applications, wherein their total magnetic losses are more dependent on the loss by parasitic currents between particles of magnetic material (dynamic loss portion) than losses by hysteresis (static losses).

Other properties of interest of this type of material include three-dimensional isotropic ferromagnetic behavior, with the possibility of improvements in thermal characteristics, flexibility in the design of processing and assembly, contributing to cost reduction in scale production.

In addition to an extensive academic literature on the development of SMC alternatives, a number of patents have been filed with different processes for the production and processing of these materials, such as iron powders and their alloys coated with organic materials such as resins (US 2012/0229245 A1) or inorganic materials such as phosphates (U.S. Pat. No. 8,187,394 B2), boron compounds (US 2010/0224822 A1) and silicates (US 2013/0181802 A1). Patent JP 2008063642 cites the formation of films via vaporization.

The SMCs with organic coating on the ferromagnetic particles present low cost and simplicity in the production of the material in the form of finished components. However, this class of composites presents a great disadvantage that is the low processing temperature possible, which considerably increases its component of static losses. In addition, degradation of the organic coating is common, also weakening its component of dynamic losses over time. As for the inorganic coatings, although usually more expensive, they expand the possibilities of processing, mainly in relation to temperature, allowing the reduction of the residual stresses and defects introduced in the compaction and, therefore, reducing the component of static losses. Nevertheless, even among the SMCs coated with inorganic materials found in the state of the art in scientific and patent literature, it is identified the need to develop strategies that increase the thermal resistance of the coating, allowing even higher processing temperatures, optimizing the loss properties of SMCs for a larger frequency band.

In the search for the state of the art, in scientific and patent literature, it was not found documents anticipating or suggesting the teachings of the present invention, so that the solution proposed herein has novelty and inventive activity in view of the state of the art.

### BRIEF DESCRIPTION OF THE INVENTION

The present invention comprises the production of soft magnetic composites (SMCs) of ferromagnetic particles coated by insulating phase, aiming at reducing their losses by parasitic currents and consequently increasing the efficiency of electrical machine components.

In a first object, the present invention presents a process for enriching the surface layer of ferromagnetic particles with alloying elements, aiming at the optimization of the subsequent coating step. This process is characterized by the enrichment of the surface layer of iron particles (or other metallic particles of magnetic material) with chemical elements that form stable compounds (oxides, nitrides, carbonitrides, hydrides and borides) such as manganese, silicon, aluminum, chromium, titanium, tantalum, vanadium etc. The enrichment can be accomplished by sublimation/resublimation, vaporization/condensation or even via interdiffusion by mechanical contact.

In a second object, the present invention comprises processes for coating the ferromagnetic particles, preferably the enriched ferromagnetic particles obtained by the first object, these being characterized by at least one of the subsequent steps:

(a) Coating the ferromagnetic particles (preferably those obtained by the process characterized in the first object) by mixing the powders by tumbling, such process being carried out by the addition of oxide materials and ferromagnetic particles to a drum containing steel spheres. The tumbling process has rotation and time controlled until the particles are coated by deposition of a very small particle size oxide material on the surface of a ferromagnetic particle larger than 50 μm. After the coating, it is carried out the compacting of the already coated powder and the sintering heat treatment of the components obtained in the compaction.

b) Coating the ferromagnetic particles (preferably those obtained by the process characterized in the first object) with boron compounds following the methodology of preparation of a solution of boric acid and isopropyl alcohol, and mixing that solution with the enriched ferromagnetic particles, promoting total wetting of the particles with this solution. After evaporation of the alcohol, the ferromagnetic particles coated with boric acid are obtained. Another way of obtaining this type of coating is to combine the ferromagnetic particles with a boriding mixture and, then, to apply a boriding thermochemical treatment. After the boriding thermochemical treatment, the ferromagnetic particles (now coated) are separated from the residues of the boriding mixture added prior to treatment. The coated ferromagnetic particles obtained through both processes are converted into parts components with the desired shape and size via compaction and sintering techniques.

c) Coating the ferromagnetic particles (preferably those obtained by the process characterized in the first object) with silicates and non-metallic submicrometric particles (for example, oxides, carbides, nitrides, fluorides etc.). This type of coating is obtained following the methodology of dispersion of non-metallic particles in an alkali metal silicate solution (sodium, potassium, among others or a mixture thereof) forming a glassy suspension of non-metallic particles; followed by wetting the ferromagnetic particles by said suspension of non-metallic particles; subsequent drying of the ferromagnetic particles wetted by the suspension of non-metallic particles, compaction and heat treatment.

These and other objects of the invention will be readily appreciated by those skilled in the art and by companies having interests in the art, and they will be described in sufficient detail for their reproduction in the following description.

### BRIEF DESCRIPTION OF THE FIGURES

In order to better define and clarify the content of the present patent application, the following figures are presented:

FIG. 1 shows a scheme of the Mn concentration profile on the iron particles.

FIG. 2 shows a mixing drum containing the steel spheres, and the base of the mixer.

FIG. 3 shows iron particles before and after mechanical processing in cylindrical drum with steel spheres. Magnification of 50× in SEM.

FIG. 4 shows a microstructure of the composition containing 4% Mn ferrite (% by volume). Scanning electron microscope 1000× magnification.

FIG. 5 shows the X-Ray Diffraction spectrum of the powder after the thermochemical treatment and the separation steps.

FIG. 6 shows a microstructure of samples with iron boride coating after heat treatment at 900 C.

FIG. 7 shows a scheme of ferromagnetic particles coated by dispersing non-metallic particles in alkali metal silicate.

FIG. 8 shows a thermogravimetric analysis under oxidizing atmosphere performed on iron powder uncoated (a), coated only with sodium silicate (b) and with glassy suspension of ceramic particles of 1.36 μm (c), 0.02 μm (d), 0.16 μm (e) and 0.1 μm (f).

FIG. 9 shows an electron microscopy image of a section prepared for metallography of Example 1.

FIG. 10 shows the result of a measurement of the magnetic losses, obtained in Example 1, for an induction frequency of 60 Hz.

FIG. 11 shows a first embodiment of the modular motor comprising (1) pole shoe, (2) stator tooth and (3) stator crown segment.

FIG. 12 shows details of the first embodiment of modular motor comprising (1) pole shoe, (2) stator tooth and (3) stator crown segment.

FIG. 13 shows a segment composed of optimized crown and tooth.

FIG. 14 shows the optimized stator shape wherein the shoe has a height greater than the stator tooth.

FIG. 15 shows another optimized stator shape wherein the shoe and the crown have a height greater than the stator tooth.

### DETAILED DESCRIPTION OF THE INVENTION

The following descriptions are given by way of example and not limiting the scope of the invention, and they will make the object of the present patent application more clearly understood.

In the case of the enrichment of the ferromagnetic particles with manganese, this can be done by mixing the ferromagnetic powder (with a particle size in the order of 80 to 400 μm) with fine powder of pure Mn or Ferromanganese of high Mn content, in the ratio of 1:0.1 to 2.

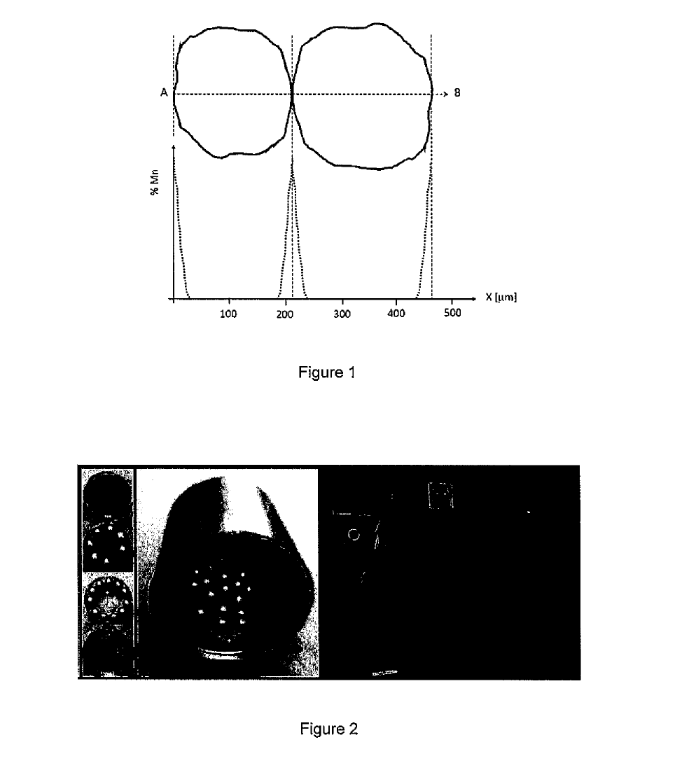

The mixture of ferromagnetic powder and manganese powder is placed in a refractory crucible (loose powder, that is, uncompacted powder) and said crucible is taken to the oven. The atmosphere for the heat treatment must be sealed, with internal pressure in the tube of about 0.2 to 0.4 atm, in order to favor the sublimation/deposition of the Mn on the iron particles. The atoms are incorporated in the surface of the iron particles due to the chemical potential gradient, either by mechanical contact between iron particles with the particles of Mn, or via the gas phase, since the Mn easily sublimates from the solid state (it has high sublimation vapor pressure). The difference lies in the fact that the enrichment occurs due to the chemical potential gradient of Mn between the treatment environment and the particles of iron. The desired enrichment should present the concentration profile as schematized in FIG. 1.

In the present example, when it is desired to form an insulating film of Mn mixed oxide, after the enrichment treatment, the powder is cooled and a mixture of the enriched powder is prepared including up to 0.8% solid lubricant and from 0.1 to 3% of a reducible oxide in the form of a fine powder selected from iron oxide, nickel oxide, cobalt oxide or even copper oxide. The concentration profile is not affected by the compaction of the desired magnetic part, that is, the pressure applied in the compaction will not change the concentration profile. Thus, after compaction that should occur at pressures greater than 700 MPa, the presence of the Mn enriched layer will remain uniform throughout the surface of the particles.

Since the oxidation of the layer has as its driving force the concentration gradient of manganese, it will be much more uniform in its thickness, as well as, the control of its thickness will depend only on the concentration of manganese and the amount of oxygen available in the interior of the part, which depends on the amount of oxygen-rich phase used as an oxygen carrier.

After compaction molding, the parts are heat treated in a neutral or reactive atmosphere, at temperatures of about 500° C.

In another example, for the SMC materials generated from the enrichment of the particles with silicon, this occurs predominantly via mechanical contact between iron particles with the Si (or Si-rich) particles mixed together. However, the ‘driving force for enrichment is the same as previously described, that is, the chemical potential gradient.

To obtain these materials, ferromagnetic powder (having a particle size of the order of 80 to 400 μm) is mixed with fine Si or ferrosilicon powder with a content of greater than 20% by weight of Si (or other Si-carrying phase) in the ratio of 1:0.1 to 1:2.

The mixture of the ferromagnetic powder and the Si powder is placed in a refractory crucible (loose powder, that is, uncompacted powder) and said crucible is taken to the oven. The atmosphere for the heat treatment must be inert with inert gas flow, at this step, avoiding Si oxidation, which would prevent the diffusion and formation of the enriched layer.

In the present example, when it is desired to form an insulating film of Si mixed oxide, after the enrichment treatment, the powder is cooled and a mixture of the enriched powder is prepared containing up to 0.8% solid lubricant and from 0.5 to 3% of a reducible oxide powder selected from iron oxide, nickel oxide, cobalt oxide or copper oxide. The particle size of this oxygen-carrying oxide should preferably be about 10 to 100 times smaller than the particle size of the ferromagnetic powder used.

Subsequently, the compaction of the parts is carried out using, for example, a compaction pressure above 700 MPa so that the maximum porosity is eliminated.

After compaction, the parts are heat treated in a neutral or reactive atmosphere, at temperatures of about 500° C.

The present invention provides a process for coating ferromagnetic particles via dry powder mixing, using a cylindrical drum and steel spheres.

FIG. 2 shows the drum for preparing mixtures, which is also used to spheroidize the ferromagnetic particles with enriched or non-enriched surface.

The ferromagnetic particles of interest have an average size ranging from 50 to 400 micrometers, depending on the application. Firstly, these particles pass through a spheroidization step in the cylindrical drum, wherein the steel spheres larger than 5 mm in diameter cause, as a function of the rotation of the drum, a mechanical conformation on the surface of the iron particles. This process promotes a change in the morphology of the particles, that is, the initial irregular surface of the particles becomes more rounded, or tend to spheroidicity.

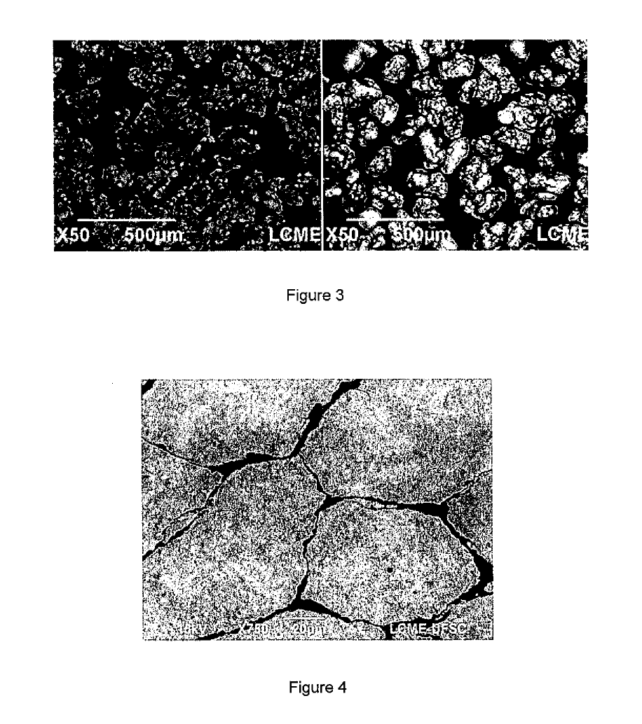

FIG. 3 shows the morphology of the particles before and after this forming process. This process of spheroidization of the ferromagnetic particles makes it possible to obtain more homogeneous and better anchored coatings, reducing the difficulties of the processing of said material and, consequently, reducing the magnetic losses in electromagnetic equipment constituted by the same.

After obtaining the spheroidized ferromagnetic particles, the oxide materials are incorporated into this same drum, and the coating process is performed.

The insulating oxide materials are embodied by soft iron, manganese, nickel, magnesium, silicon, aluminum, titanium, boron and ferrite oxides, each imparting a different feature in the coating of the ferromagnetic particles.

For the formation of the composites deriving from the mixture of iron particles and insulating oxides, oxides concentrations of 0.1 to 10% by volume, preferably by percentages of about 0.5 to 1% were used, wherein the oxides employed have size variations between 0.02 to 20 micrometers. Such a process is accomplished by the addition of oxide materials and ferromagnetic particles to the drum containing steel spheres. The tumbling process must occur until the particles are coated by deposition of the very small particle size oxide material on the surface of a much larger ferromagnetic particle.

FIG. 4 shows the microstructure of a SMC sample composed of pure iron coated with Manganese Ferrite produced by the method described above.

Subsequently, the compacting of the parts is carried out, whose subsequent heat treatment is carried out in a neutral or reactive atmosphere, at temperatures of about 500° C.

By using ferromagnetic particles, preferably enriched and spheroidized (as described in paragraphs 32 and 44), the coating involving insulating oxides was performed from boron compounds, wherein boric acid (H₃BO₃) was used due to its characteristic of transformation into boron oxide and water at low temperatures. The manner of adding the boric acid was via liquid, through a solution containing boric acid and isopropyl alcohol. Said solution was prepared with the aid of a heating base with magnetic stirring, the concentration of boric acid in the solution can be from 1 g/L to 20 g/L and a ratio of powder mass per volume of solution of 2 g/L to 20 g/L can be used. The powder wetted with the solution is dried at room temperature and forced convection to increase the speed of the process.

The layer formed of boric acid on the surface of the iron particles depends, among other factors, on the acid content in the solution and also on the ratios between iron particle mass and the volume of the solution. Iron particles with different percentages of boric acid show differences in the layer. A mass percentage of boric acid between 0.05% and 1.0%, preferably between 0.1% and 0.5% may be used.

After the boric acid-containing powder was obtained, it is carried out a mixing with the solid lubricant, this being any compaction lubricant. The lubricant content may be between 0.1% and 1%, preferably between 0.3% and 0.5%. The function of the lubricant is to reduce the friction between the powder particles, thus avoiding the breakage of the boric acid layer, very high contents of lubricant tend to leave residual porosity after the heat treatment, reducing the magnetic permeability.

In the present invention, the compacting pressure may be between 700 MPa and 1000 MPa, preferably between 800 MPa and 900 MPa. In order to increase the final density of the composite, the compaction can be made warmly.

Finally, the compacted parts undergo a heat treatment in an inert or reactive atmosphere, at temperatures between 500° C. and 700° C. During this heat treatment, the boric acid added via liquid to the surface of the ferromagnetic particles passes through chemical reactions at temperatures between 150° C. and 200° C. The end product of these reactions is boron oxide and water vapor. Part of this generated vapor reacts with the surface of the ferromagnetic particles, finally obtaining an insulation formed of an iron oxide compound and boron.

The coating involving iron boride is produced in two steps, the first is the boriding thermochemical treatment and the second is the separation of the boriding mixture and the iron particle. 80% Fe and 20% boriding mixture, by mass, were mixed; the bonding mixture can be commercial mixtures, considering the ease of subsequent separation. The heat treatment can be done at a temperature between 900° C. to 1100° C., the holding time between 60 minutes to 240 minutes.

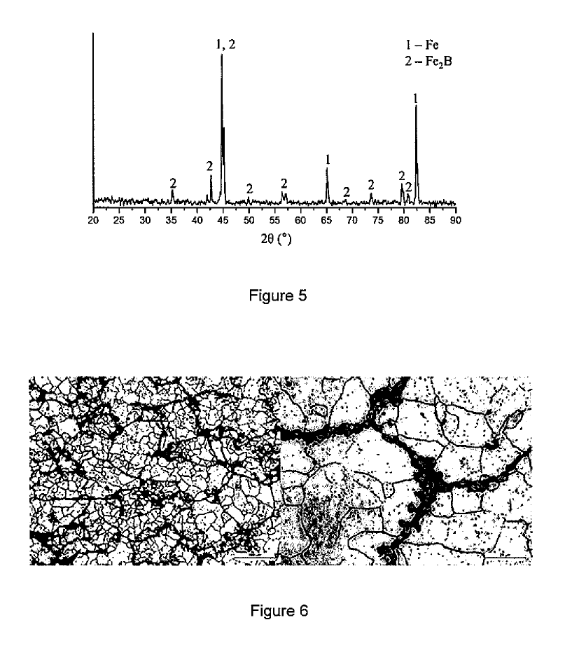

After the boriding thermochemical treatment, it is necessary the separation of the ferromagnetic powder with the boride layer and the compounds of the bonding mixture. The ferromagnetic powder with a layer of iron boride obtained should preferably contain the Fe₂B phase, as shown in FIG. 5e, and the layer thickness may be between 0.1 and 2 μm.

The obtained bonded powder is then mixed with lubricant. The compacting pressure may be between 700 MPa and 1000 MPa, preferably between 800 MPa and 900 MPa. The heat treatment of the SMCs produced with the borided ferromagnetic powder may be carried out at temperatures between 500° C. and 1100° C., preferably between 700° C. and 900° C.

Table 1 shows the results of density, electrical resistivity and magnetic properties of SMCs developed with electrical insulation of boron compounds:

TABLE 1
Density, electrical resistivity and magnetic properties.

| | Heat | | | | |
|---|---|---|---|---|---|
| | treatment | | Electrical | | Losses [W/kg] |
| | temperature | Density | resistivity | | (800 mT - |
| Sample | [° C.] | [g/cm³] | [μΩ · m] | μmax | 60 Hz) |
| Fe₂B | 900 | 7.01 | 0.37 | 330 | 25.7 |
| 0.1% H₃BO₃ | 600 | 7.28 | 3.28 | 308 | 5.9 |
| 0.3% H₃BO₃ | | 7.22 | 7.80 | 218 | 5.7 |
| 0.1% H₃BO₃ | 500 | 7.24 | 54.07 | 288 | 6.8 |
| 0.3% H₃BO₃ | | 7.13 | 62.04 | 200 | 6.4 |

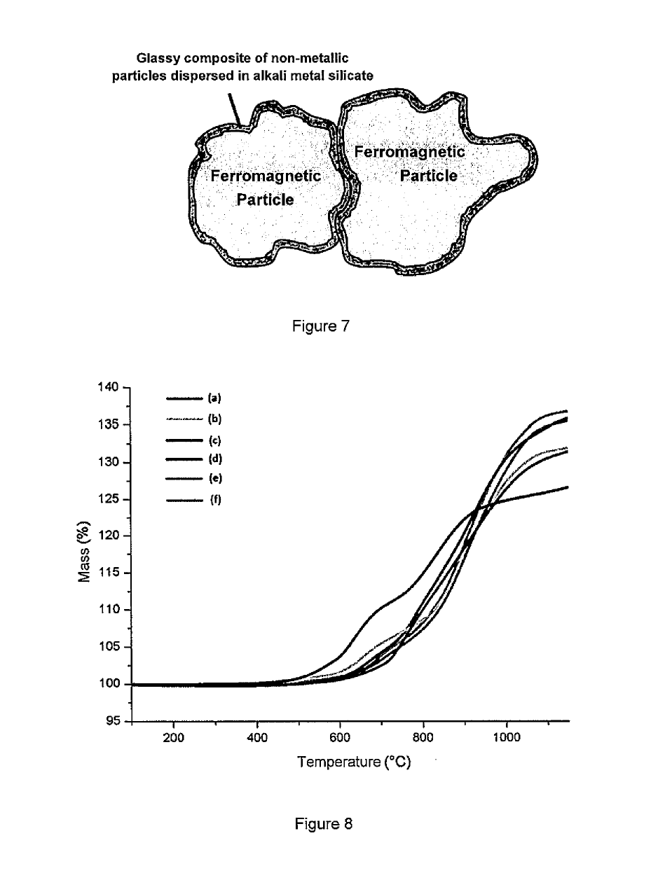

The execution of the process for coating the ferromagnetic particles, preferably spheroidized and enriched (as described in paragraphs 32 and 44), with glassy suspension of submicrometric particles (FIG. 7), imparted a higher electrical resistance to the coating, thus being possible to reduce the coating thickness in order to maximize the magnetic material and increase its efficiency. It was also observed an increase in the thermal resistance of the coating, allowing higher processing temperatures of the material. The iron particles that were coated with glassy suspension follow the following steps:

1—Non-metallic particles (for example, Al₂O₃, TiO₂, ZrO₂, WC, B₂O₃) are dispersed in an aqueous solution of alkali metal silicate (for example, Na₂O.nSiO₂, K₂O.mSiO₂ or a mixture thereof);

2—A ferromagnetic base powder is immersed in this silicate dispersion; the spare liquid is removed, remaining the ferromagnetic powder soaked by the silicate dispersion;

3—The product is dried, leaving the ferromagnetic powder coated by a solid layer of alkali metal silicate with particles dispersed in the glassy phase.

The viscosity of the coating solution made in Step 1 increases with increasing concentrations of silicate and dispersed particles. Viscosity also increases with decreasing mean particle size. The higher the viscosity of said solution and its wettability in the ferromagnetic phase, the greater the thickness of the layer deposited on the base powder.

The higher the ionic radius of the alkali metal of the silicate (Fr>Cs>Rb>K>Na>Li), the greater the electrical resistivity of the silicate, allowing a lower thickness of insulation layer to be deposited on the particles to decrease the parasitic currents. In addition, various properties associated with alkaline ion movement of a mixture of different silicates (for example, (1-X)K₂O.XNa₂O.nSiO₂) have large variations with orders of magnitude of difference compared to the isolated precursors. For example, a mixture of the form (1-X)Na₂O.XK₂O.4SiO₂, with X about 0.5, exhibits a resistivity almost 10 times greater than a pure sodium or potassium silicate.

The smaller the submicrometric particles dispersed in Step 1, the greater their specific area, making their thermal absorption greater during the heat treatment. This also increases the viscosity of the glassy phase after it reaches the glass transition. These effects allow an increase in the heat treatment temperature without loss of the integrity of the coating.

To illustrate the effect of the suspended particles on the coating during the heat treatment, FIG. 8 shows a thermogravimetric analysis under oxidizing atmosphere performed on iron powder uncoated (a), coated only with sodium silicate (b) and with glassy suspension of ceramic particles of 1.36 μm (c), 0.02 μm (d), 0.16 μm (e) and 0.1 μm (f). While the uncoated iron powder begins to oxidize (to increase its mass) significantly from 500° C., the material coated only with sodium silicate maintains its oxidation resistance up to approximately 600° C. Samples containing ceramic particles dispersed in the glassy phase show the appreciable increase in oxidation rate only above 650° C., depending on the average particle size. The curves show an increase in the oxidation temperature of the samples, indicating that the glassy coating coats the entire surface of the particles, preventing the oxygen from interacting with the iron. The oxidation of the particles only becomes appreciable when the glassy coating decreases its viscosity sufficiently to flow out of the surface of the iron. When ceramic particles are dispersed in the sodium silicate, they absorb part of the thermal energy, causing it to take longer to achieve the glass transition of the coating. After this glass transition, the particles further increase the viscosity of the silicate, making it difficult to flow into the pores and keeping the material longer between the ferromagnetic particles.

Also during heat treatment, the particles dispersed in the silicate act as activators of the crystallization of the glassy phase, this effect being intensified for smaller particles. The crystalline phase of the silicates has a higher melting temperature than the temperature at which their amorphous form is fluidified. By adjusting the heating rate, temperature and holding time or by performing cooling and heating cycles, the use of the product produced by this invention can be processed at much higher temperatures than the simple use of pure glassy coatings.

For even higher temperatures, depending on the composition of the dispersed particles and the silicate used, they begin to dissolve in the glassy phase forming more viscous and resistive compounds during the heat treatment. For example, treated at a temperature above 800° C., alumina particles dispersed in sodium silicate dissolve forming sodium aluminosilicate. Thus, by adjusting parameters of the heat treatment cycle, such as heating rate, temperature and holding time, it is possible to optimize the properties for each object produced by the process described in this invention.

### EXEMPLIFICATIONS OF METHODOLOGIES AND APPLICATIONS

### Example 1

Iron particles having a mean diameter of 222 μm were dispersed in an aqueous solution of sodium silicate (11 mg/ml) with 11 mg/ml of particles of Al₂O₃ having a mean diameter of 20 nm dispersed. The spare solution is discarded and the particulate material is dried at 85° C. for 2 hours in a vacuum oven.

The product is mixed with 0.5% by weight of lubricant and compacted via uniaxial compaction at 800 MPa. The compacted green body is heat treated under inert atmosphere with a level at 400° C. for 30 minutes for extraction of the lubricant, and then a level at 600° C. for 30 minutes.

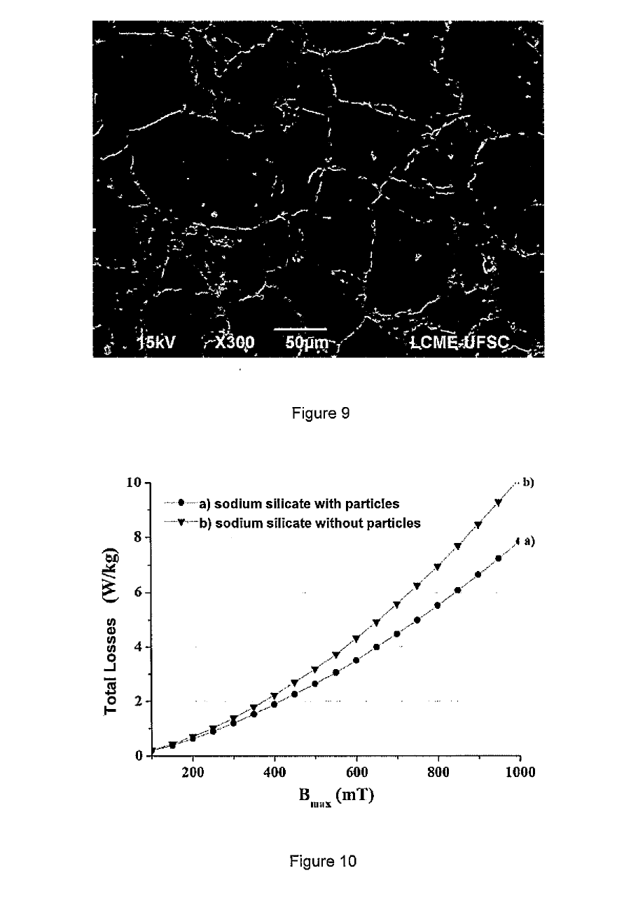

FIG. 9 shows an electron microscopy image of a section prepared for metallography of the component produced with the respective product described in this example. It is possible to identify an insulating phase completely permeating the iron particles. This product had a resistivity of 12.39 μΩ·m.

For the purpose of comparison, the same base iron powder having a mean size of 222 μm was coated only by the sodium silicate without the nanoparticle dispersion, compacted and heat treated under the same parameters cited in this example. The electrical resistivity value of this material was 1.28 μΩ·m, indicating that the dispersion of nanoparticles in the glassy phase increased the integrity and electrical resistivity of the material.

FIG. 10 shows the measurement of the magnetic losses of these two materials measured for an induction frequency of 60 Hz. Under a maximum induction of 450 mT, for example, the product containing the alumina nanoparticles dispersed in the sodium silicate presents 84% of the total losses of the product coated only with sodium silicate.

Table 2 shows the total loss value measured for an induction frequency of 60 Hz and maximum induction of 450 mT for materials produced as described in this example, with and without alumina nanoparticles, with final level of heat treatment at T=500° C. and 600° C.

TABLE 2
Total losses.

| Iron Coated with | | |
|---|---|---|
| Sodium Silicate | Thermal Level | Total Losses |
| without nanoparticles | 500° C. | 2.55 W/kg |
| with nanoparticles | 500° C. | 2.57 W/kg |
| without nanoparticles | 600° C. | 2.69 W/kg |
| with nanoparticles | 600° C. | 2.26 W/kg |

The increase in heat treatment temperature from 500° C. to 600° C. causes the flow of sodium silicate without nanoparticles to the pores, as discussed above, allowing contact between the iron particles and increasing the total losses due to parasitic currents. This not only does not occur at 600° C. when using the process described in this invention, dispersing nanoparticles in the silicate, as at a higher temperature there is a greater relaxation of the residual stresses generated during compaction and exhibiting a decrease of 12% of total losses in relation to the sample treated at 500° C.

### Example 2

As an example of application of the SMCs materials presented in this invention, it is proposed the construction of an electric motor comprising stator tooth, pole shoe and stator crown.

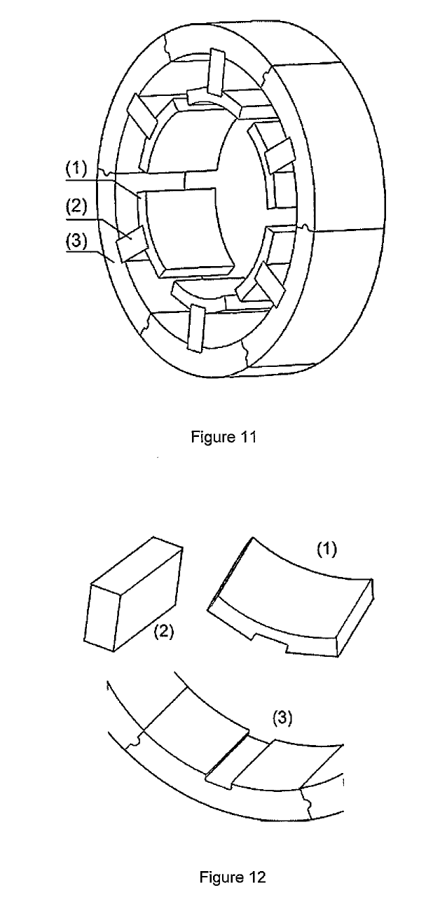

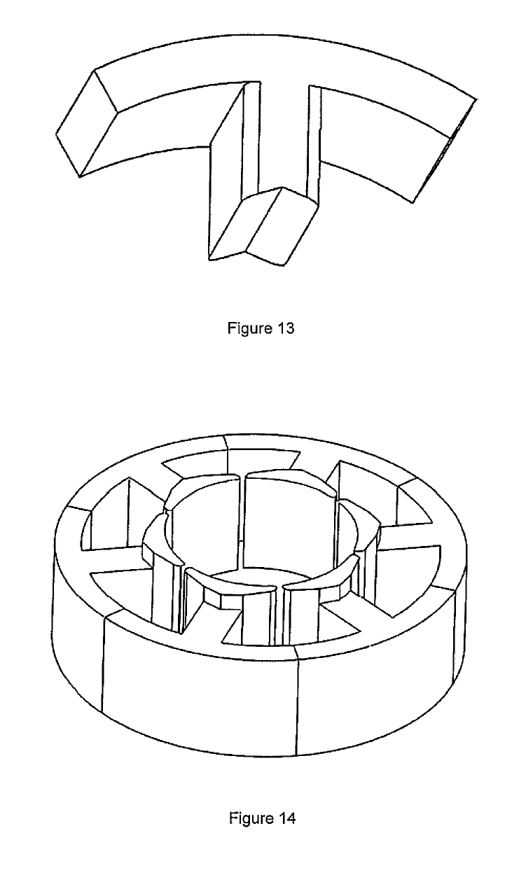

The electric motor manufactured with the use of the material constituting iron particles and insulating presents some advantages in its constructive form, such as modularity and three-dimensional design. FIGS. 11, 12 and 13 present the basic concept of motor design and modularization. Said modularity enables the use of preformed coils without the need to insert the coils through the openings of the groove. Such an assembly allows the modularization of the motor, that is, the motor is composed of embedded parts and not of a single entire part. In this way, the cost of producing the motor can be reduced due to the lower cost of making the coils, as well as additional rolling costs.

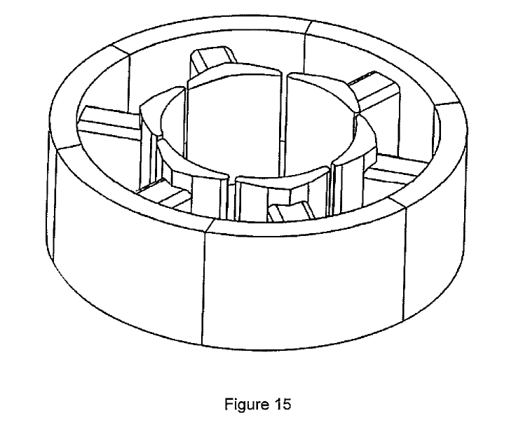

The pole shoe located on the motor stator is embodied as comprising an optimized two- or three-dimensional shape for the magnetic flow lines, reducing iron losses and material volume while increasing motor performance, as shown in FIG. 14. The optimized shape for the flow lines comprises being adopted for the sides of the shoe or towards the height of the shoe, wherein the shoe has a height greater than the stator tooth, as also indicated in FIG. 15.

The assembly process of the electric motor comprising an association between the stator crown segments, an association between the stator tooth and the stator crown segment, and an association between the pole shoe and the stator tooth, wherein the stator crown segment comprises a housing, for example, dovetail type, for association with the upper surface of the stator tooth, and wherein the pole shoe has a housing for association with the lower part of the stator tooth. Such an assembly allows the modularization of the motor, that is, the motor is composed of embedded parts and not of a single entire part.

### Example 3

A mixture (ratio 1:1) of spheroidized particles of pure iron and FeMn (with high Mn content) were conditioned in a refractory crucible and heat-treated in a resistive oven. The treatment temperature was 700° C., the oven atmosphere being inert and sealed. During this treatment the sublimation/deposition of the Mn on the iron particles occurred, wherein a percentage of manganese of about 12% could be quantified in the surface of the iron particles.

After the heat treatment step, it was necessary to carry out the separation of the enriched powder and the FeMn powder. As the average particle diameter of the two powders is distinct, 220 micrometers to the iron powder and 100 micrometers to the FeMn powder, a sieving can be performed to obtain the enriched iron powder.

Subsequently, the enriched iron powder was coated with boric acid (H₃BO₃) to promote the oxidation of the enriched surface during the heat treatment. This oxidation is caused by the release of water that occurs during the transformations of boric acid at low temperatures.

The manner of adding boric acid to the enriched iron powder was via liquid, through a solution containing boric acid and isopropyl alcohol. Said solution was prepared with the aid of a heating base with magnetic stirring, wherein the concentration of boric acid in the solution was 0.8 g/L and the mass percentage of boric acid in the enriched iron powder was 0.1%. The powder was wetted with this solution, and then dried at room temperature with forced convection to increase the speed of the process.

After the boric acid-containing powder was obtained, it was mixed with 0.3% solid lubricant. The compacting of the specimens was performed at a pressure of 800 MPa and, finally, the compacted parts underwent a heat treatment in an inert atmosphere, at a temperature of 500° C. for 30 minutes. During this heat treatment, the boric acid added via liquid to the surface of the ferromagnetic particles passes through chemical reactions at temperatures between 150° C. and 200° C. The end product of these reactions is boron oxide and water vapor, where part of that vapor reacts with the surface of the enriched iron particles thus forming a mixed oxide of iron and manganese.

Table 3 shows the results of density, electrical resistivity and magnetic properties of the SMCs developed with electrical insulation of mixed oxides of iron and manganese and boron oxide:

TABLE 3
Density, electrical resistivity and magnetic properties.

| | Heat treatment | | Electrical | Losses |
|---|---|---|---|---|
| | temperature | Density | resistivity | [W/kg] (800 |
| Sample | [° C.] | [g/cm³] | [μΩ · m] | mT - 60 Hz) |
| Fe enriched with | 500 | 6.95 | 295 | 8 |
| Mn + 0.1% H₃BO₃ | | | | |

### Example 4

A mixture (ratio 1:1) of spheroidized particles of pure iron and FeMn (with high Mn content) were conditioned in a refractory crucible and heat-treated in a resistive oven. The treatment temperature was 700° C., the oven atmosphere being inert and sealed. During this treatment the sublimation/deposition of the Mn on the iron particles occurred, wherein a percentage of manganese of about 15% could be quantified in the surface of the iron particles.

After the heat treatment step, it was necessary to carry out the separation of the enriched powder and the FeMn powder. As the average particle diameter of the two powders is distinct, 220 micrometers to the iron powder and 100 micrometers to the FeMn powder, a sieving can be performed to obtain the enriched iron powder.

Subsequently, the powder was subjected to the coating process with non-metallic particles dispersed in alkali metal silicate, as described in item b) of the second object of the present invention and in more detail in paragraph 59, using sodium silicate and alumina nanoparticles (20 nm) for the coating suspension, both at a concentration of 1 mg/ml. The powder was dried at a temperature of 75° C. under vacuum forming a manganese-enriched iron composite coated by 0.02% by mass of sodium silicate with dispersed alumina nanoparticles.

The composite formed was mixed at 0.3% by mass of lubricant, compacted at a pressure of 800 MPa and, finally, treated under oxidizing atmosphere at 500° C. for 30 minutes. During this heat treatment the glassy composite of the coating, in addition to providing electrical insulation, releases water of crystallization of the silicate, oxidizing the surface of the enriched iron particles and forming a mixed oxide of iron and manganese, which provides an even greater electrical resistivity for the material.

Table 4 shows the results of density, electrical resistivity and magnetic properties of the SMCs developed with electrical insulation of mixed oxides of iron and manganese and sodium silicate with dispersion of alumina nanoparticles:

TABLE 4
Density, electrical resistivity and magnetic properties.

| | Heat treatment | | Electrical | Losses |
|---|---|---|---|---|
| | temperature | Density | resistivity | [W/kg] (800 |
| Sample | [° C.] | [g/cm³] | [μΩ · m] | mT - 60 Hz) |
| Fe enriched | 500 | 6.95 | 18 | 8 |
| with Mn + 0.02% | | | | |
| liquid glass | | | | |

The examples shown herein are for the sole purpose of exemplifying one of the innumerable ways of carrying out the invention, but without limiting the scope thereof.

1. Soft magnetic composite composed of ferromagnetic particles coated with inorganic material capable of generating electrical insulation between them, minimizing the effect of parasitic currents in electrical applications, characterized by the fact that it is obtained by a process comprising the following sub-steps:
I. coating of the ferromagnetic particles with inorganic material;
II. mechanical conformation of the particulate material composed of the ferromagnetic particles coated with inorganic material; and
III. heat treatment of the composite formed by the ferromagnetic particles coated with inorganic material.

2. Process, according to claim 1, characterized by the fact that the ferromagnetic particles are formed by materials with high relative magnetic permeability such as iron, nickel, cobalt and their alloys; the ferromagnetic particles being provided with an average size between 50 μm and 500 μm and more preferably between 150 μm and 300 μm.

3. Process, according to claim 1, characterized by the fact that the ferromagnetic particles are subjected to a previous step of spheroidization by means of tumbling, in which these ferromagnetic particles are subjected to a tumbling-drum provided with metal spheres, and further characterized by the fact that the ferromagnetic particles are formed by materials with high relative magnetic permeability such as iron, nickel, cobalt and their alloys; the ferromagnetic particles being provided with an average size between 50 μm and 500 μm and more preferably between 150 μm and 300 μm.

4. Process, according to claim 1, characterized by the fact that the coating of inorganic material is obtained by a process wherein the ferromagnetic particles undergo a superficial enrichment with chemical elements such as manganese, silicon, aluminum, chromium, titanium, tantalum, vanadium and the like, which form stable compounds of high electrical resistivity (oxides, nitrides, carbonitrides and borides); followed by a subsequent oxidation process of the layers enriched by an oxidizing agent during the heat treatment, which is a reducible oxide selected from iron oxide, nickel oxide, cobalt oxide and copper oxide, or a compound which releases water vapor during, such as boric acid or alkali metal silicate, and further characterized by the fact that the ferromagnetic particles are formed by materials with high relative magnetic permeability such as iron, nickel, cobalt and their alloys; the ferromagnetic particles being provided with an average size between 50 μm and 500 μm and more preferably between 150 μm and 300 μm.

5. Process, according to claim 4, characterized by the fact that the step of enriching the ferromagnetic particles with manganese comprises the sub-steps of:
I. mixing the ferromagnetic particles with fine powder of pure Mn or ferromanganese of high Mn content in the ratio of 1:0.1 to 2;
II. heat treatment of the mixture of powders in a sealed atmosphere at a temperature that may range from 500° C. to 1000° C., in order to promote the incorporation of the manganese atoms on the surface of the ferromagnetic particles (enrichment) due to the chemical potential gradient, both by mechanical contact, and via gas phase from the sublimation of manganese;
III. separation of enriched ferromagnetic particles from the FeMn powder or iron powder with high concentration of manganese.

6. Process, according to claim 4, characterized by the fact that the step of enriching the ferromagnetic particles with silicon comprises the sub-steps of:
I. mixing the ferromagnetic particles with fine Si or Ferrosilicon powder having a content higher than 20% by weight of Si (or another Si-carrying phase), in the ratio of 1:0.1 to 1:2;
II. heat treatment of the powder mixture in reducing atmosphere with reducing gas flow;
III. separation of enriched ferromagnetic particles from the fine Si or Ferrosilicon powder.

7. Process, according to claim 1, characterized by the fact that the oxidizing agent of the enriched layer mixed is a reducible oxide powder less stable than the oxide formed by the element incorporated in the enriched layer, such as iron oxide, nickel oxide, cobalt oxide, copper oxide, or the like; and these are mixed by dry tumbling using a concentration of oxides of from 0.01% to 10% by volume, more preferably from 0.1% to 1%, and further characterized by the coating of inorganic material is obtained by a process wherein the ferromagnetic particles undergo a superficial enrichment with chemical elements such as manganese, silicon, aluminum, chromium, titanium, tantalum, vanadium and the like, which form stable compounds of high electrical resistivity (oxides, nitrides, carbonitrides and borides); followed by a subsequent oxidation process of the layers enriched by an oxidizing agent during the heat treatment, which is a reducible oxide selected from iron oxide, nickel oxide, cobalt oxide and copper oxide, or a compound which releases water vapor during, such as boric acid or alkali metal silicate, and further characterized by the fact that the ferromagnetic particles are formed by materials with high relative magnetic permeability such as iron, nickel, cobalt and their alloys; the ferromagnetic particles being provided with an average size between 50 μm and 500 μm and more preferably between 150 μm and 300 μm.

8. Process, according to claim 4, characterized by the fact that the oxidizing agent of the enriched layer is a boron compound (for example, boric acid, metaboric acid, tetraboric acid, ammonium tetraborate, pentaborate, peroxyborate, or the like), deposited by liquid route, wherein the ferromagnetic particles are wetted with a solution comprising the boron compound in a ratio of ferromagnetic particle mass per solution volume between 2 g/L and 20 g/L.

9. Process, according to claim 8, characterized by the fact that the solution comprising the boron compound is prepared from the mixture of boric acid and isopropyl alcohol, the mass percentage of boric acid in the solution being between 0.05% to 1.0%, preferably between 0.1% to 0.5%.

10. Process, according to claim 8, characterized by the fact that the solution comprising the boron compound is prepared from the mixture of boric acid in aqueous solution of alkali metal silicate, the mass percentage of boric acid in the solution being between 0.05% and 1.0% and the concentration of alkali metal silicate being between 0.001 mg/ml and 15 mg/ml.

11. Process, according to claim 1, characterized by the fact that the coating of the ferromagnetic particles with insulating inorganic material occurs via boriding, which comprises the sub-steps of:
I. mixing the ferromagnetic particles with a boriding mixture, in the mass ratio of 80% ferromagnetic particles and 20% bonding mixture;
II. heat treating the mixture obtained in sub-step (I) at a temperature between 900° C. and 1100° C.; and
III. separating the ferromagnetic particles with the boride layer obtained in sub-step (II) and the compounds of the boriding mixture;
the boride layer being the insulating inorganic material coating of the ferromagnetic particles, and further characterized by the fact that the ferromagnetic particles are formed by materials with high relative magnetic permeability such as iron, nickel, cobalt and their alloys; the ferromagnetic particles being provided with an average size between 50 μm and 500 μm and more preferably between 150 μm and 300 μm.

12. Process, according to claim 1, characterized by the fact that the coating of the ferromagnetic particles with insulating inorganic material occurs via a glassy suspension formed by non-metallic particles dispersed in alkali metal silicate, which comprises the sub-steps of:
I. dispersing the non-metallic particles into an aqueous solution of alkali metal silicate;
II. wetting the ferromagnetic particles by said alkali metal silicate solution with dispersed non-metallic particles obtained in (I); and
III. drying the ferromagnetic particles wetted by the alkali metal silicate solution with dispersed non-metallic particles obtained in (II);
and wherein:
the non-metallic particles are formed by high electrical resistivity ceramic materials selected from oxides, carbides, fluorides or the like, the average size of the non-metallic particles being between 0.005 μm and 1 μm and more preferably between 0.01 μm and 0, 4 μm, and further characterized by the fact that the ferromagnetic particles are formed by materials with high relative magnetic permeability such as iron, nickel, cobalt and their alloys; the ferromagnetic particles being provided with an average size between 50 μm and 500 μm and more preferably between 150 μm and 300 μm.

13. Process, according to claim 12, characterized by the fact that the alkali metal silicate solution is composed of the water dilution of one or more silicates, the molar ratio of the silica molecules to the alkali metal oxides of the alkali metal silicates being between 0.5 and 8 and more preferably between 1.5 and 4.

14. Process, according to claim 12, characterized by the fact that the alkali metal silicate solution contains a concentration of silicate or mixture of silicates between 0.001 mg/ml and 15 mg/ml, and more preferably between 0.01 mg/ml and 1 mg/ml, and further characterized by the fact that the alkali metal silicate solution is composed of the water dilution of one or more silicates, the molar ratio of the silica molecules to the alkali metal oxides of the alkali metal silicates being between 0.5 and 8 and more preferably between 1.5 and 4.

15. Process, according to claim 12, characterized by the fact that the concentration of non-metallic particles dispersed in the alkali metal silicate solution is between 0.001 mg/ml and 15 mg/ml, and more preferably between 0.01 mg/ml and 1 mg/ml, and further characterized by the fact that the alkali metal silicate solution is composed of the water dilution of one or more silicates, the molar ratio of the silica molecules to the alkali metal oxides of the alkali metal silicates being between 0.5 and 8 and more preferably between 1.5 and 4, and the alkali metal silicate solution contains a concentration of silicate or mixture of silicates between 0.001 mg/ml and 15 mg/ml, and more preferably between 0.01 mg/ml and 1 mg/ml.

16. Process, according to claim 4, characterized by the fact that the oxidizing agent of the enriched layer is the alkali metal silicate with concentration of non-metallic particles dispersed in the coating alkali metal silicate solution between 0 mg/ml and 15 mg/ml, and more preferably between 0 mg/ml and 1 mg/ml.

17. Processing of the soft magnetic composites, formed by the ferromagnetic particles enriched and mixed with an oxidizing agent, according to claim 1, characterized by the fact that the heat treatment of a compacted composite is carried out with a temperature between 100° C. and 1100° C., more preferably between 500° C. and 800° C., imparting mechanical strength to the composite and ensuring the oxidation of the enriched layer and generating the electrical insulation between the ferromagnetic particles.
